(19) United States
(12) Patent Application Publication
(10) Pub. No.: US 2017/0282348 A1
(43) Pub. Date: Oct. 5, 2017

(54) MULTIPURPOSE CLEANING TOOL HAVING AN INTERCHANGABLE HEAD

(71) Applicant: MOSHE MARK, BROOKLYN, NY (US)

(72) Inventor: MOSHE MARK, BROOKLYN, NY (US)

(21) Appl. No.: 15/496,955

(22) Filed: Apr. 25, 2017

Related U.S. Application Data
(63) Continuation-in-part of application No. 13/728,925, filed on Dec. 27, 2012.

(51) Int. Cl. B25G 1/04; A47L 13/12; A47L 13/44; A47L 13/253

(52) U.S. Cl. CPC B25G 1/04; A47L 13/253; A47L 13/12; A47L 13/44

(57) ABSTRACT

A telescopic handle has a first segment. A second segment slides inside the first segment. A flat surface is formed on the second segment. The flat surface prevents the second segment from rotating within the first segment. A plurality of notches is formed on the flat surface. A pair of locking devices is provided. A first locking device is attached to one end of the first segment. The first locking device is configured to allow the second segment to slide within the first locking device and secure the second segment to the first segment. A second locking device is provided to secure a tool head to a distal end of the second segment.

### RELATED APPLICATIONS

The present application is a Continuation-In-Part (CIP) application of U.S. patent application entitled, “A MULTIPURPOSE CLEANING TOOL HAVING AN INTERCHANGABLE HEAD”, Filed Dec. 27, 2012, and having U.S. Ser. No. 13/728,925 in the name of Moshe Y. Mark

### BACKGROUND

Embodiments of this disclosure relate generally to a multi-purpose cleaning tool, and more particularly, to a multi-purpose cleaning tool having a plurality of interchangeable cleaning heads wherein each cleaning head has a coupling mechanism for releasably coupling the cleaning head to a telescoping tool handle, the telescoping tool handle having a locking mechanism for easily adjusting a length of the telescoping tool handle.

Cleaning tools like brooms, mops, and the like have been made with wooden, non-telescopic handles for many years. More recent versions of such tools have changed the handles from wood to lighter materials such as aluminum, fiberglass, or the like. The problem with existing tools is that the user is limited to one tool at a time, and each tool can only be used for a single task. Existing tools also places the user at a financial disadvantage because for each task, a different tool must be used and/or purchased.

Therefore, a need exists to provide a tool and method to overcome the above issues. The tool would have a plurality of interchangeable cleaning heads to allow the tool to perform multiple functions. Each interchangeable cleaning head would have a releasable coupling to simply and securely fasten the interchangeable cleaning head to the tool handle.

### SUMMARY

In accordance with one aspect of the present disclosure, a telescopic handle is disclosed. The telescopic handle has a first segment. A second segment slides inside the first segment. A flat surface is formed on the second segment. The flat surface prevents the second segment from rotating within the first segment. A plurality of notches is formed on the flat surface. A pair of locking devices is provided. A first locking device is attached to one end of the first segment. The first locking device is configured to allow the second segment to slide within the first locking device and secure the second segment to the first segment. A second locking device is provided to secure a tool head to a distal end of the second segment.

In accordance with one aspect of the present disclosure, a telescopic handle is disclosed. A telescopic handle has a first segment. A second segment slides inside the first segment. A flat surface is formed on the second segment that prevents the second segment from rotating within the first segment. A plurality of notches is formed on the flat surface, wherein the plurality of notches are approximately evenly spaced along a length of the flat surface. A first locking device is attached to one end of the first segment. The first locking device is configured to allow the second segment to slide within the first locking device to secure the second segment to the first segment. The first locking device has a first locking device hollow housing having a first open end and a second open end. The first segment is inserted into the first open end coupled to an interior of the first locking device hollow housing. A first locking device channel is formed in the first locking device hollow housing. The first locking device channel exposes the flat surface of the second segment when the second segment is inserted into the second open end of the first locking device hollow housing. A first locking device lever is positioned within the first locking device hollow housing. The first locking device lever engages one or more of the plurality of notches to hold the second segment at a desired length within the hollow housing.

In accordance with one aspect of the present disclosure, a telescopic handle is disclosed. The telescopic handle has a first segment. A second segment slides inside the first segment. A flat surface is formed on the second segment preventing the second segment from rotating within the first segment. A plurality of notches is formed on the flat surface and is approximately evenly spaced along a length of the flat surface. A first locking device is attached to one end of the first segment and configured to allow the second segment to slide within the first locking device to secure the second segment to the first segment. The first locking device has a first locking device hollow housing having a first open end and a second open end, the first segment inserted into the first open end coupled to an interior of the first locking device hollow housing. A first locking device channel is formed in the first locking device hollow housing, the first locking device channel exposing the flat surface of the second segment when the second segment is inserted into the second open end of the first locking device hollow housing. A first locking device lever is positioned within the first locking device hollow housing, the first locking device lever engages one or more of the plurality of notches to hold the second segment at a desired length within the hollow housing. A second locking device is attached to one end of the second segment and configured to allow a tool head to slide within the second locking device to secure the tool head to the second segment. The second locking device has a second locking device hollow housing having a first open end and a second open end, the second segment inserted into the first open end of the second locking device hollow housing and coupled to an interior of the second locking device hollow housing. A second locking device is channel formed in the second locking device hollow housing, the second locking device channel exposing the tool head when the tool head is inserted into the second open end of the second locking device hollow housing. A second locking device lever is positioned within the second locking device hollow housing, the second locking device lever engaging a notch of the tool head to hold the tool head within the second locking device hollow housing.

The foregoing and other objects, features, and advantages of the invention will be apparent from the following, more particular, description of the preferred embodiments of the invention, as illustrated in the accompanying drawings.

### BRIEF DESCRIPTION OF THE DRAWINGS

Embodiments of the disclosure will become more fully understood from the detailed description and the accompanying drawings, wherein:

FIG. 1 is a front view of a cleaning tool package containing pieces of a cleaning tool.

FIG. 2 is a front view of a handle member of the cleaning tool of FIG. 1;

FIG. 3a is a cross-sectional view of a adapter locking apparatus in an unlocked arrangement;

FIG. 3b is the cross sectional view of the adapter locking apparatus in a locked arrangement;

FIG. 4 is a front view of a tool head of the cleaning tool of FIG. 1;

FIG. 5 is a cross-sectional view of the tool head and the adapter locking apparatus in operation;

FIG. 6 is a front view of a telescoping handle member having a handle locking apparatus;

FIG. 7 is a cross-sectional view of the handle locking apparatus;

FIG. 8 is a front view of the tool cleaning tool;

FIG. 9 is another embodiment of the handle member and tool head of the present invention;

FIG. 10 is a magnified view showing the handle member of FIG. 9 engaging the tool head of FIG. 9;

FIG. 11 is a top view of a telescoping handle member having a handle locking apparatus in accordance with one exemplary embodiment;

FIG. 12 is a cross-sectional view of a telescoping handle member having a handle locking apparatus of FIG. 11 in accordance with one exemplary embodiment;

FIG. 13 is a bottom view of a telescoping handle member having a handle locking apparatus of FIG. 12 in accordance with one exemplary embodiment;

FIG. 14 is a perspective view of a second segment of the telescoping handle member having a handle locking apparatus of FIG. 11 in accordance with one exemplary embodiment;

FIG. 15 is a perspective view of a locking device used in the telescoping handle member having a handle locking apparatus of FIG. 11 in accordance with one exemplary embodiment;

FIG. 16 is a bottom perspective view of the locking device of FIG. 15; and

FIG. 17 is a side view of the locking device of FIG. 15.

### DETAILED DESCRIPTION

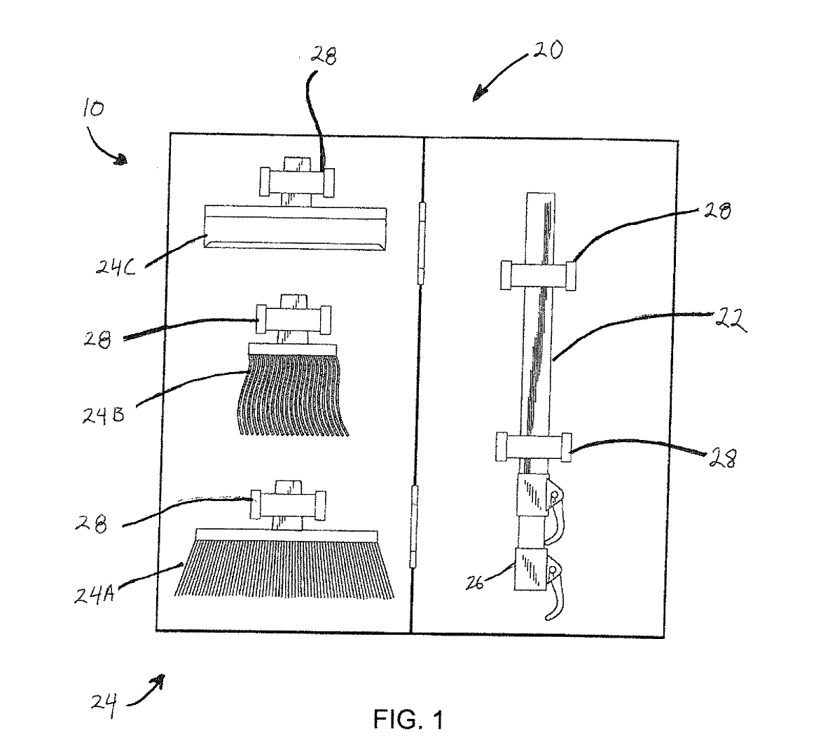

Referring to FIG. 1, a cleaning package 10 is shown. The cleaning package 10 may comprise a plurality of components that in combination make up a cleaning tool 20. In the present embodiment, the cleaning package 10 may contain a handle member 22 and a plurality of tool heads 24. The handle member 22 and the plurality of tool heads 24 may be secured to the cleaning package in a plurality of manners. In the embodiment shown in FIG. 1, the handle member 22 and the plurality of tool heads 24 may be secured to the cleaning package 10 using strap members 28.

The cleaning tool 20 may have a handle member 22. The handle member 22 may be formed of light weight but sturdy material such plastic, aluminum or the like. The listing is given as an example and should not be seen in a limiting manner. The handle member 22 may be a solid handle or it may be a telescopic handle. In the embodiment shown in FIG. 1, the handle 22 is a telescoping handle.

Located at one end of the handle 22 is a locking apparatus 26. The locking apparatus 26 may be used to easily secure and remove various tool heads 24 to the handle 22. The tool heads 24 may include but is not limited to a broom 24A, a mop 24B, a squeegee 24C or other similar tool heads. The above listing is given as an example and should not be seen in a limiting manner.

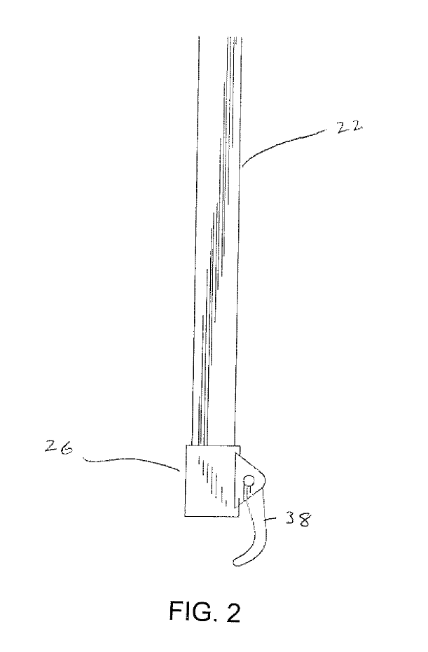

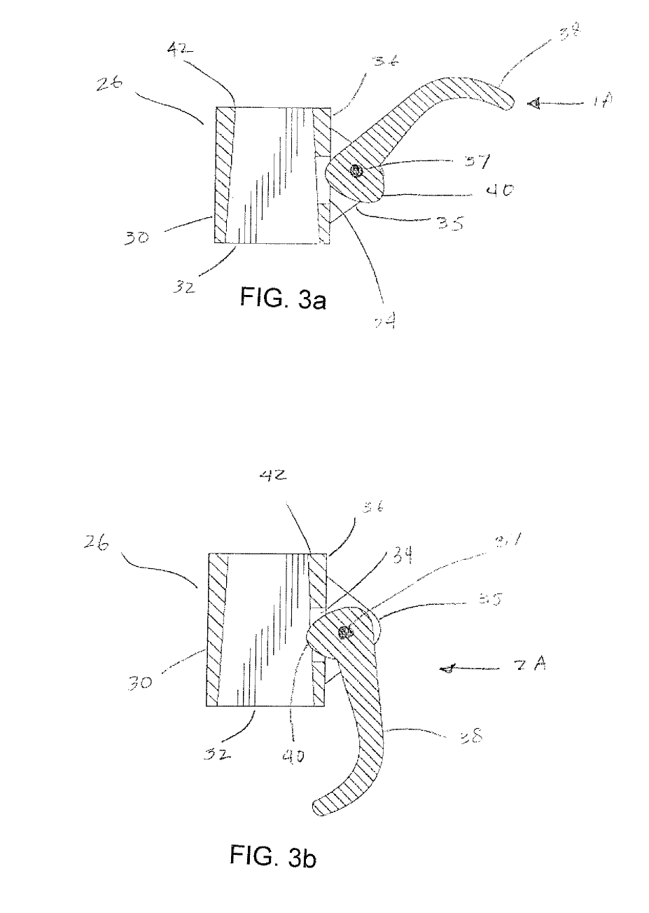

Referring now to FIGS. 2-3b, the locking apparatus is shown in more detail. The locking apparatus 26 may comprise an adapter housing 30. The adapter housing 30 may take on a plurality of different shapes. In the present embodiment, the adapter housing 30 is substantially tubular in shape. The adapter housing 30 may have a hollow interior having open ends 32A and 32B. One of the open ends 32A or 32B may be used to receive one end of the handle 22. The other open end 32A or 32B may be used to receive one of the tool heads 24 to be used.

The housing 30 of the locking apparatus 26 may have a tapered interior 42. The tapered interior 42 may correspond to a portion of the tool heads 24 which may be inserted into the locking apparatus 26. Further, the tapered interior 42 may be used to guide a portion of the tool head 24 into the adapter housing 30. An interaction between the tool heads 24 and the adapter locking apparatus 26 will be discussed in details below.

The adapter housing 30 may further include an aperture 34 on the perimeter 36 of the adapter housing 30. Adjacent the aperture 34, a lever 38 may be coupled to the adapter housing 30. The lever 38, may be pivotally couple to the adapter housing 30. In the present invention, the adapter housing 30 may include at least one support member 35, and the lever 38 may connect to the at least one support member 35 using a pin 37. The lever 38 may move about a single direction along its vertical axis.

In addition, the lever 38 may also include a protrusion member 40. The protrusion member 40 is integrally joined to the lever 38 at one end. The movement of the lever 38 and thus the protrusion member 40 may result in unlocked 1A and locked 2A positions. This arrangement may operate such that the movement of the lever 38 causes the protrusion member 40 to enter the aperture 34 when the lever is in the locked arrangement 1A, and to exit the aperture 34 when the lever 38 is in the unlocked arrangement 2A.

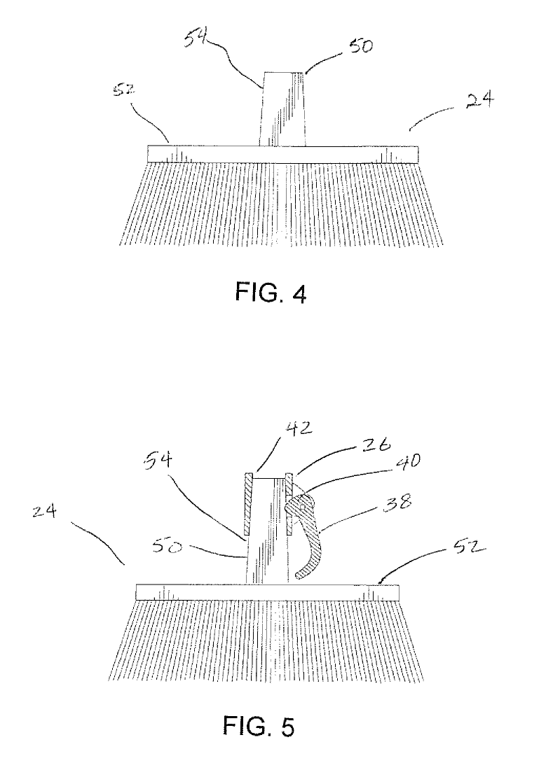

Referring now to FIGS. 4 and 5, an exemplary embodiment of one of the tool heads 24 is shown. While the Figures show a broom head 24A, the below description may be applicable to the other tool heads 24.

The tool head 24 may include a tool head adapter 50. The tool head adapter 50 may be integrally joined to the body 52 of the tool head 24. In different embodiments of the tool head adapter 50, the tool head adapter 50 may comprise of diverse shapes. Here, the tool head adapter 50 has a substantially conical shape. The shape of the tool head adapter 50 may also correspond to the interior 42 of the housing 30 of the adapter locking apparatus 26. In particular embodiments of the tool head adapter 50, the tool head adapter 50 may comprise a resilient outer surface 54. Having used resilient material on the resilient outer surface 54 of the tool head adapter 50 permits the shape of the tool head adapter 50 to be flexible under pressure. The shape of the resilient outer surface 54 may revert back to its recess shape once the pressure is removed.

In an operational example, the adapter locking apparatus 26 receives the tool head adapter 50 therein. The shape of the tool head adapter 50 may facilitate the insertion of the tool head adapter 50 into the adapter locking apparatus 26. The interior 42 of the adapter locking apparatus 26 receives the tool head adapter 50 near to the body 52 of the tool head 24. Thereafter, the lever 38 may be moved from the unlocked arrangement 1A to the locked arrangement 2A. The lever in the locked arrangement 2A, may engage the protrusion member 40 on the resilient outer surface 54 of the tool head adapter 50, and hence, causing the protrusion member 40 to exert pressure over the resilient outer surface 54. This arrangement may cause the tool head adapter 50 to tightly and securely remain within the adapter locking apparatus 26.

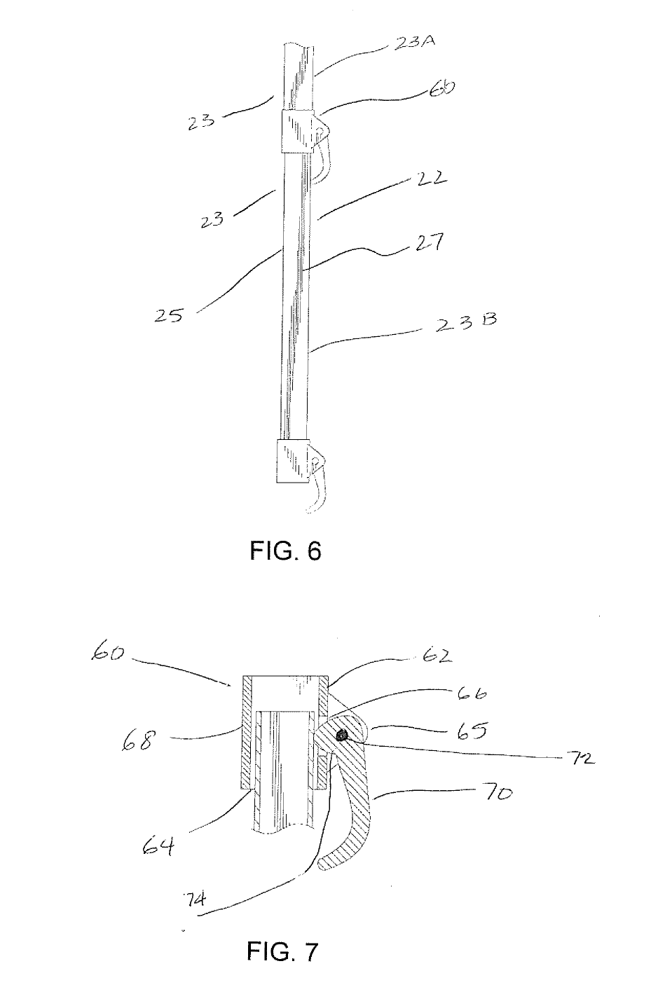

Referring now to FIG. 6, a particular embodiment of the handle member 22 is shown. In the present embodiment, the handle member 22 is a telescoping handle member. The telescopic embodiment of the handle member 22 allows a user to adjust the length of the handle member 22 as he or she may desire. The handle member 22 may comprise of a plurality of segments 23. In the presents embodiment the plurality of segments 23 include a first segment 23A and a second segment 23B. The first segment 23A may be an elongated segment. Here, the first segment 23A is an elongated hallow tube. Furthermore, the second segment 23B may also be an elongated hollow tube. The second segment 23B may be partially disposed inside the first segment 23A. Also, the second segment 23B is slidably movable inside the first segment 23A to allow a user to adjust the length of the tool handle 22. Moreover, the second segment 23B may include a resilient circumference 25. The resilient circumference 25 may allow the shape of a portion of the outer surface of the second segment 23B to slightly change under pressure.

In addition, the first segment 23A may include a handle locking apparatus 60 at one end. The first segment 22A is partially disposed inside the handle locking apparatus 60. The handle locking apparatus 60 may operate between locked and unlocked arrangement. The locked arrangement may be used to lock the second segment 23B with respect to the first segment 23A, in order to adjust the length of the handle member 22 as desired.

Referring to FIG. 7, the handle locking apparatus 60 may comprise a handle housing 62. The handle housing 62 may be available in diverse shapes. In the present embodiment, a substantially tubular housing is used. Further, the handle housing 62 may be a hollow housing having at least one outlet end 64. The outlet end 64 may be used to receive the second segment therein. The handle housing 60 may further include an aperture 66 on the perimeter 68 of the housing 60. Adjacent the aperture 66, a lever 70 may be coupled to the handle housing 60. The lever 60, may pivotally couple to the handle housing 60. In present embodiment, the adapter housing 62 may include at least one support member 65, and the lever 70 may connect to the at least one support member 65 using a pin 72. The lever 70 may move about a single direction along its vertical axis. The movement of the lever 70 may result in unlocked and locked arrangements for the handle locking apparatus 70. In addition, the lever 70 may also include a protrusion member 74. The protrusion member 74 is integrally joined to the lever 70 at one end. This arrangement may operate such that the movement of the lever 70 causes the protrusion member 74 to enter the aperture 66 when the lever is in the locked arrangement 18, and to exit the aperture 64 when the lever 70 is in the unlocked arrangement 2B.

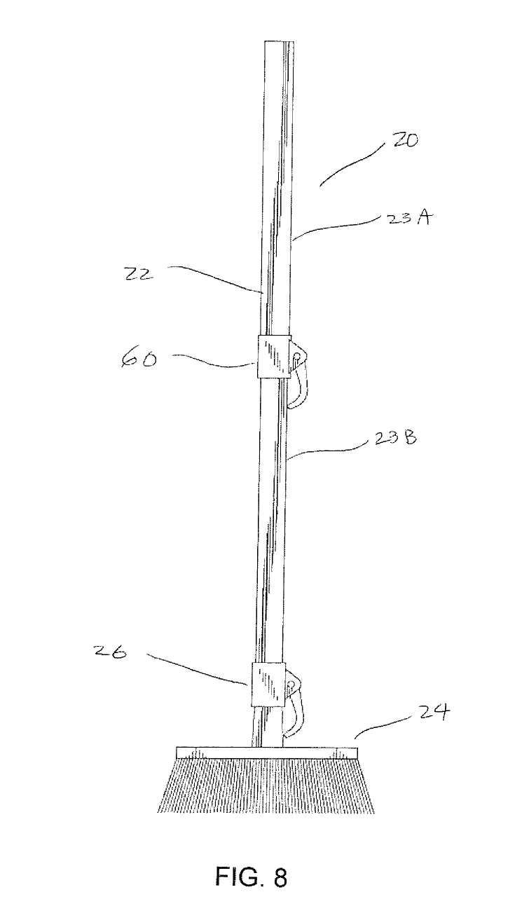

Referring now to FIG. 8, an operational example of the cleaning tool 20 is shown. The handle member 22 may adopt diverse tool heads 24 at one end. In present embodiment, the adapter locking mechanism 26 is used to attach a tool head 24 to the handle member 22. Furthermore, the adapter locking apparatus 26 may secure the tool head 24 to the handle member 22 in the locked arrangement. The user may change the purpose of the cleaning tool 20 by unlocking the adapter locking apparatus 26 and placing a different tool head 24. The handle member 22 may also adopt various lengths as the user desires. In example, the user may leave the handle locking apparatus 60 on the unlock arrangement and then slidably move the second segment 23B of the handle member 24 into the first segment 23A to find his or her desire length for the handle member 22. Thereafter, the user may move the handle locking apparatus 60 to the locked arrangement, therefore securing the first segment 23A with respect to the second segment 23B.

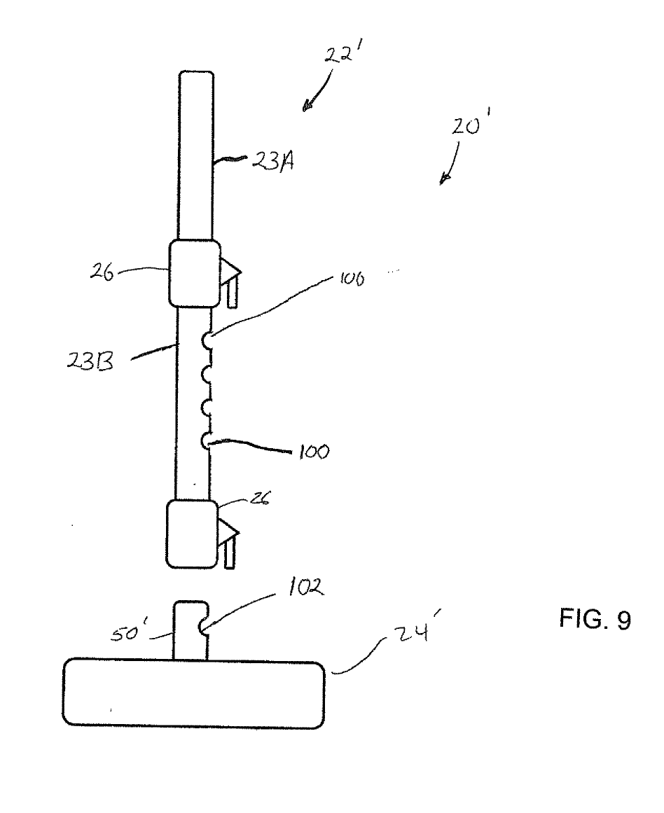

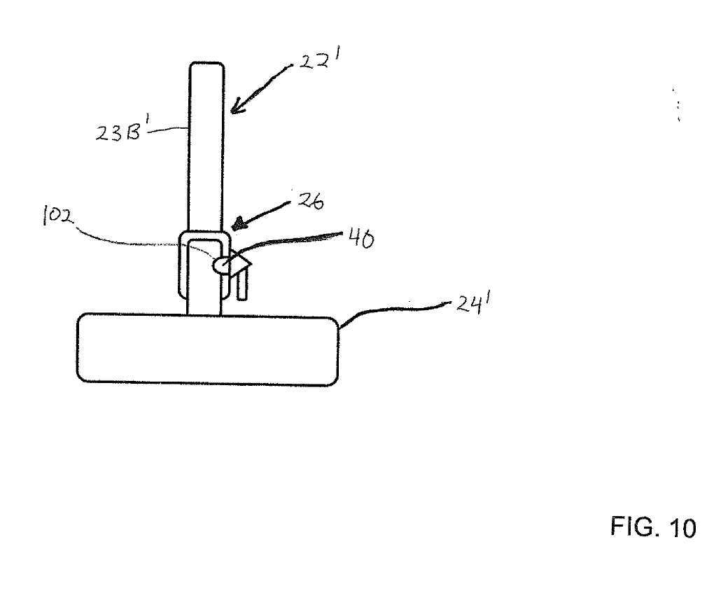

Referring now to FIGS. 9 and 10, another embodiment of the handle member 22′ and tool head 24′ are shown. In this embodiment, the handle member 22′ is similar to the handle member 22. In the present embodiment, the handle member 22′ may include a plurality of indentions 100. The plurality of the indentions 100 may be placed on at least a portion of the body of the handle member 22′. Each indention 100 may be equally spaced apart from a successive another. This arrangement may permit the user to change the length of the handle member 22′ to certain predetermined lengths.

The plurality of indentions 100 may be used to securely engage the locking apparatus 26 to the handle member 22′. Here, each indention 100 may also be seized corresponding to the body of the protrusion member 40 (FIG. 7) of the locking apparatus 26. This arraignment may allow the protrusion member 40 to be inserted into the indentation 100, and hence, securely maintaining the handle member 22′ with respect to the locking apparatus 26.

In the present embodiment, the tool head adapter 50′ has a substantially tubular shape. The shape of the tool head adapter 50′ generally corresponds to the interior 42 of the housing 30 of the adapter locking apparatus 26. The tool head adapter 50′ may include at least one indentation member 102. The indentation member 102 may be utilized to securely connect the tool head 24′ to the handle member 22′. Here, the indentation member 102 may be sized corresponding to the body of the protrusion member 40 of the locking apparatus 26. Once the tool head adapter 50′ is inserted into the locking apparatus 26, the at least one indentation member 102 may receive the protrusion member 40 securely therein, and hence, firmly connecting the tool head 24′ to the handle member 22.

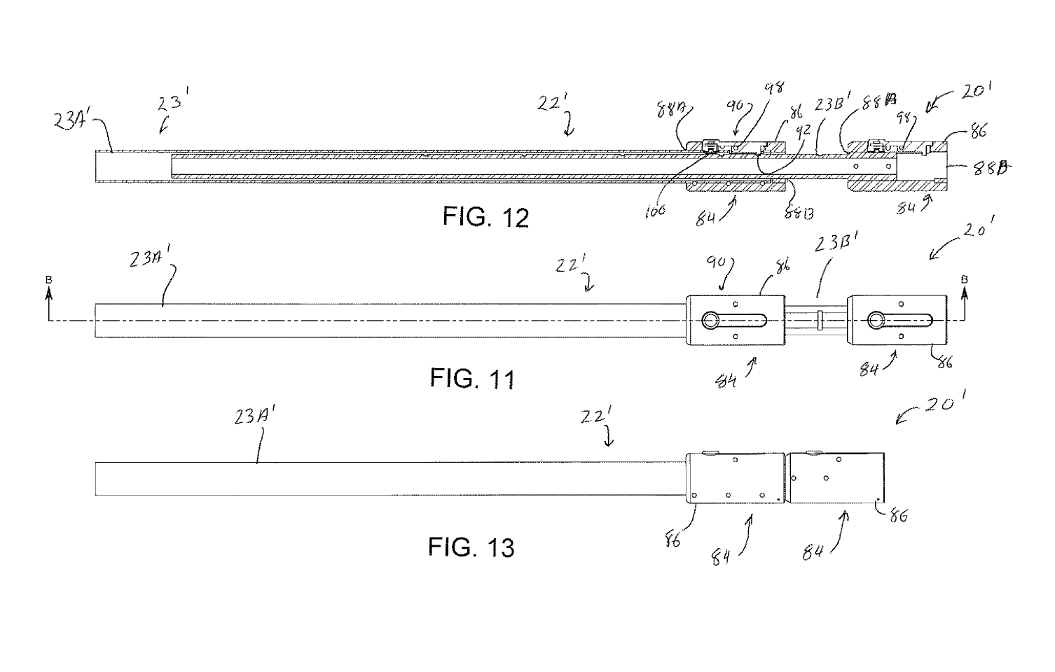

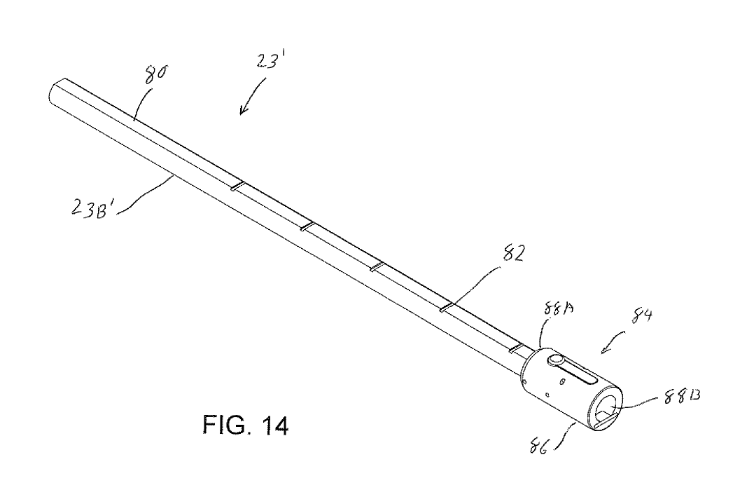

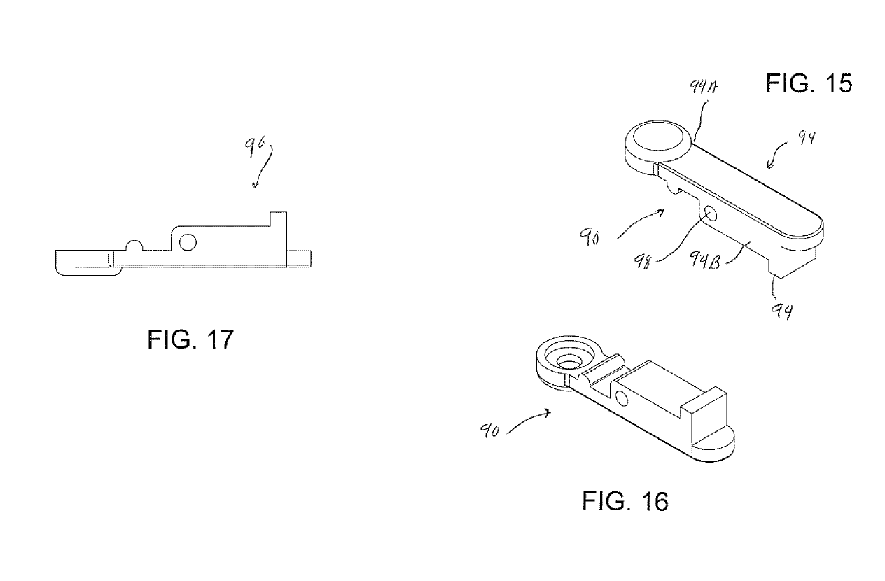

Referring to FIGS. 11-17, another exemplary embodiment of a cleaning tool 20′. In the present embodiment, the cleaning tool 20′ may contain a handle member 22′ on which the plurality of tool heads 24 (FIG. 1) may be removably attached. The handle member 22′ may be formed of light weight but sturdy material such plastic, aluminum or the like. The listing is given as an example and should not be seen in a limiting manner. The handle member 22′ may be a solid handle or it may be a telescopic handle.

In the present embodiment, the handle member 22′ may be a telescoping handle which may allow a user to adjust the length of the handle member 22′ as he or she may desire. The handle member 22′ may be comprised of a plurality of segments 23′. In the present embodiment, the plurality of segments 23′ include a first segment 23A′ and a second segment 23B′. While two segments 23′ are shown, additional segments 23′ may be used without departing from the spirit and scope of the present invention.

The first segment 23A′ may be an elongated segment. Here, the first segment 23A′ may be an elongated hollow tube. Furthermore, the second segment 23B′ may also be an elongated hollow tube. The second segment 23B′ may be configured to be partially disposed inside the first segment 23A′. The second segment 23B′ may further be configured to be slidably movable within the first segment 23A′ to allow a user to adjust the length of the handle member 22′.

The second segment 23B′ may have a flat section 80 formed thereon. The flat section 80 may run along a top surface of the second segment 23B′. The flat section 80 may run along a majority of a length of the second segment 23B′. The flat section 80 may be used to prevent the second segment 23B′ located within the first segment 23A′ from rotating within the first segment 23A′.

A plurality of notches 82 may be formed in the second segment. In accordance with one embodiment, the plurality of notches 82 may be formed on the flat section 80. The plurality of notches 82 may be formed along the length of the flat section and may be equally spaced along the length of the flat section 80. The notches 82 may be used to adjust the length of the handle member 22′. The notches 82 may be used in conjunction with a locking device 84 to secure the second segment 23B′ with respect to the first segment 23A′, in order to adjust the length of the handle member 22′ as desired. The locking device 84 may also be used to secure one of the tool heads 24 to the handle member 22′.

The locking device 84 may have a housing 86. The housing 86 may be a hollow structure having a pair of openings 88A and 88B. The housing 86 may come in various geometric shapes. In accordance with one embodiment, the housing 86 is tubular in shape.

The housing 86 may be attached to one end of the first segment 23A′. In accordance with one embodiment, one end of the first segment 23A′ may be inserted in to the opening 88A and extend partially into the housing 86 around the areas of the opening 88A. An exterior surface of the first member 23A′ may be secured to an interior surface of the housing 86. The interior of the housing 86 around where the opening 88B is located is generally unobstructed and is not coupled to the first segment 23A′. The first segment 23A′ generally does not extend more than half way into the housing 86. However, this should not be seen in a limiting manner.

The second opening 883 may be used to receive the second segment 23B′ therein. The second segment 23B′ may be dimensioned to slide within the second opening 88B of the housing 86 and into the first segment 23A′.

The housing 86 may be attached to one end of the second segment 23B′. In accordance with one embodiment, a distal end of the second segment 23A′ may be inserted in to the opening 88A and extend partially into the housing 86 around the areas of the opening 88A. An exterior surface of the second member 23B′ may be secured to an interior surface of the housing 86. The interior of the housing 86 around where the opening 88B is located is generally unobstructed and is not coupled to the second segment 23B′. The second segment 23B′ generally does not extend more than half way into the housing 86. However, this should not be seen in a limiting manner. One of the tool heads 24 may be inserted into the opening 883 and extend partially into the housing 86.

Located within the interior of the housing 86 is a locking switch 90. The locking switch 90 may be used to engage and hold the second segment 23B′ at various lengths within the housing 86 when the second segment 23B′ is inserted into the housing 86. The locking switch 90 may be used to secure one of the tool heads 24 to the second segment 233′.

A channel 92 may be formed in the housing 86. The channel 92 may be configured to allow a tab member 94C of the locking switch 90 to be positioned within and protrude out of the channel 92. The tab member 94 may be used to engage and hold the second segment 23B′ at various lengths within the housing 86 when the second segment 235′ is inserted into the housing 86 and to secure one of the tool heads 24 to the distal end of the second segment 23B′.

The channel 92 may be used to expose the second segment 23B′ being inserted into the housing 86. In accordance with one embodiment, the channel 92 may expose at least one of the plurality of notches 82 that may be formed along the length of the flat section 80 of the second segment 23B′ when the second segment 23B′ is being inserted into the housing 86. Thus, a used may slide the second segment 23B′ to a desired length within the housing 86 and then the locking switch 90 may be used to engage and hold the second segment 23B′ at this length.

In accordance with one embodiment of the present invention, the locking switch 90 may be a hinged lever 94. The hinged lever 94 may be configured in a staircase pattern. The hinged lever 94 may have an activation area 94A. The activation area 94A may allow a user to press and release the hinged lever 94 to lock and unlock the locking switch 90. Extending outward and downward from the activation area 94A is a body area 94B. The body area 94B may be used to hingely secure the hinged lever 94 within the housing 86. Extending outward and downward from the body area 94B is the tab member 94C, the tab member 94C may be configures to extend down from the hinged lever 94 through the channel 92 which may allow the hinged lever 94 to engage one or more of the plurality of notches 82 that may be formed on the flat section 80 of the second segment 23B′ to hold the second segment 23B′ at a desired length within the housing 86 and/or to a notch 102 (FIG. 9) formed in the tool head 24 to secure the tool heads 24 to the distal end of the second segment 23B′.

The locking switch 90 may be hingely secure within the housing 86. In accordance with one embodiment, a pivot pin 98 or similar device may be used to pivotably couple the locking switch 90 within the housing 86. A spring 100 may also be provided. The spring 100 may be positioned in the interior of the housing 86 and below the activation area 94A of the hinged lever 94. The spring 100 exerts an upward force thereby causing the hinged lever 94 to pivot downward about the pivot pin 98 and pressing the tab member 94C through the channel 92 which may allow the hinged lever 94 to engage one or more of the plurality of notches 82 and/or to the notch 96 formed in a tool head 24.

While embodiments of the disclosure have been described in terms of various specific embodiments, those skilled in the art will recognize that the embodiments of the disclosure may be practiced with modifications within the spirit and scope of the claims.

What is claimed is:

1. A telescopic handle comprising:
a first segment; and
a second segment, wherein the second segment slides inside the first segment;
a flat surface formed on the second segment, the flat surface preventing the second segment from rotating within the first segment;
a plurality of notches formed on the flat surface; and
a pair of locking devices, wherein first locking device is attached to one end of the first segment, the first locking device configured to allow the second segment to slide within the first locking device and secure the second segment to the first segment and a second locking device to secure a tool head to a distal end of the second segment.

2. The telescopic handle of claim 1, wherein the flat surface runs approximately a length of the second segment.

3. The telescopic handle of claim 1, wherein the plurality of notches are approximately evenly spaced along a length of the flat surface.

4. The telescopic handle of claim 1, wherein each of the pair of locking devices comprises:
a hollow housing having a first open end and a second open end;
a channel formed in the housing; and
a lever positioned within the housing.

5. The telescopic handle of claim 4, wherein the lever is a spring loaded lever.

6. The telescopic handle of claim 4, wherein the lever is a spring loaded lever comprising:
a staircase configured lever having at least one tab extending down there from;
a pivot pin to pivotably couple the staircase lever in the housing; and
a spring positioned under the staircase lever to exert an upward force on the staircase lever.

7. The telescopic handle of claim 4, wherein the lever is a spring loaded lever comprising:
a staircase lever, the staircase lever having an activation area allowing pressing and releasing of the staircase lever, a body area extending outward and downward from the activation area, the body area used to hingely secure the staircase lever within the housing, and a tab member extending outward and downward from the body area, the tab member configured to extend down from the staircase lever through the channel allowing the staircase lever to engage one or more of the plurality of notches formed on the flat section of the second segment to hold the second segment at a desired length within the housing and to a notch formed in a tool head to secure the tool head to a distal end of the second segment; and
a pivot pin to pivotably couple the staircase lever in the housing.

8. The telescopic handle of claim 7, comprising a spring positioned under the staircase lever to exert an upward force on the staircase lever.

9. A telescopic handle comprising:
a first segment; and
a second segment, wherein the second segment slides inside the first segment;
a flat surface formed on the second segment, the flat surface preventing the second segment from rotating within the first segment;
a plurality of notches formed on the flat surface, wherein the plurality of notches are approximately evenly spaced along a length of the flat surface; and
a first locking device attached to one end of the first segment, the first locking device configured to allow the second segment to slide within the first locking device to secure the second segment to the first segment, wherein the first locking device comprises:
a first locking device hollow housing having a first open end and a second open end, the first segment inserted into the first open end coupled to an interior of the first locking device hollow housing;
a first locking device channel formed in the first locking device hollow housing, the first locking device channel exposing the flat surface of the second segment when the second segment is inserted into the second open end of the first locking device hollow housing; and
a first locking device lever positioned within the first locking device hollow housing, the first locking device lever engage one or more of the plurality of notches to hold the second segment at a desired length within the hollow housing.

10. The telescopic handle of claim 9, comprising a second locking device attached to one end of the second segment, the second locking device configured to allow a tool head to slide within the second locking device to secure the tool head to the second segment.

11. The telescopic handle of claim 10, wherein the second locking device comprises:
a second locking device hollow housing having a first open end and a second open end, the second segment inserted into the first open end of the second locking device hollow housing and coupled to an interior of the second locking device hollow housing;
a second locking device channel formed in the second locking device hollow housing, the second locking device channel exposing the tool head when the tool head is inserted into the second open end of the second locking device hollow housing; and
a second locking device lever positioned within the second locking device hollow housing, the second locking device lever engaging a notch of the tool head to hold the tool head within the second locking device hollow housing.

12. The telescopic handle of claim 9, wherein the flat surface runs approximately a length of the second segment.

13. The telescopic handle of claim 9, wherein the first locking device lever is a first locking device spring loaded lever.

14. The telescopic handle of claim 9, wherein the first locking device lever is a first locking device spring loaded lever comprising:
a first locking device staircase lever having at least one tab extending down there from;
a first locking device pivot pin to pivotably couple the first locking device staircase lever in the first locking device housing; and
a first locking device spring positioned under the first locking device staircase lever to exert an upward force on the first locking device staircase lever.

15. The telescopic handle of claim 9, wherein the first locking device lever is a first locking device spring loaded lever comprising:
a first locking device staircase lever having a first locking device lever activation area allowing pressing and releasing of the first locking staircase lever, a first locking device lever body area extending outward and downward from the first locking device lever activation area, the first locking device lever body area used to hingely secure the first locking staircase lever within the first locking device housing, and a first locking device lever tab member extending outward and downward from the first locking device lever body area, the first locking device lever tab member configured to extend down through the channel allowing the first locking device staircase lever to engage one or more of the plurality of notches formed on the flat section of the second segment to hold the second segment at a desired length;
a first locking device pivot pin to pivotably couple the first locking device staircase lever in the first locking device housing; and
a first locking device spring positioned under the first locking device staircase lever to exert an upward force on the first locking device staircase lever.

16. The telescopic handle of claim 11, wherein the second locking device lever is a second locking device spring loaded lever comprising:
a second locking device staircase lever having at least one tab extending down there from;
a second locking device pivot pin to pivotably couple the second locking device staircase lever in the second locking device housing; and
a second locking device spring positioned under the second locking device staircase lever to exert an upward force on the second locking device staircase lever.

17. The telescopic handle of claim 11, wherein the second locking device lever is a second locking device spring loaded lever comprising:
a second locking device staircase lever having a second locking device lever activation area allowing pressing and releasing of the second locking staircase lever, a second locking device lever body area extending outward and downward from the second locking device lever activation area, the second locking device lever body area used to hingely secure the second locking staircase lever within the second locking device housing, and a second locking device lever tab member extending outward and downward from the second locking device lever body area, the second locking device lever tab member configured to extend down through the channel allowing the second locking device staircase lever to engage one or more of the plurality of notches formed on the flat section of the second segment to hold the second segment at a desired length;
a second locking device pivot pin to pivotably couple the second locking device staircase lever in the second locking device housing; and
a second locking device spring positioned under the second locking device staircase lever to exert an upward force on the second locking device staircase lever.

18. A telescopic handle comprising:
a first segment;
a second segment, wherein the second segment slides inside the first segment;
a flat surface formed on the second segment, the flat surface preventing the second segment from rotating within the first segment;
a plurality of notches formed on the flat surface, wherein the plurality of notches are approximately evenly spaced along a length of the flat surface;
a first locking device attached to one end of the first segment, the first locking device configured to allow the second segment to slide within the first locking device to secure the second segment to the first segment, wherein the first locking device comprises:
a first locking device hollow housing having a first open end and a second open end, the first segment inserted into the first open end coupled to an interior of the first locking device hollow housing;
a first locking device channel formed in the first locking device hollow housing, the first locking device channel exposing the flat surface of the second segment when the second segment is inserted into the second open end of the first locking device hollow housing; and
a first locking device lever positioned within the first locking device hollow housing, the first locking device lever engage one or more of the plurality of notches to hold the second segment at a desired length within the hollow housing; and
a second locking device attached to one end of the second segment, the second locking device configured to allow a tool head to slide within the second locking device to secure the tool head to the second segment, wherein the second locking device comprises:
a second locking device hollow housing having a first open end and a second open end, the second segment inserted into the first open end of the second locking device hollow housing and coupled to an interior of the second locking device hollow housing;
a second locking device channel formed in the second locking device hollow housing, the second locking device channel exposing the tool head when the tool head is inserted into the second open end of the second locking device hollow housing; and
a second locking device lever positioned within the second locking device hollow housing, the second locking device lever engaging a notch of the tool head to hold the tool head within the second locking device hollow housing.

19. The telescopic handle of claim 18, wherein the first locking device lever is a first locking device spring loaded lever comprising:
a first locking device staircase lever having a first locking device lever activation area allowing pressing and releasing of the first locking staircase lever, a first locking device lever body area extending outward and downward from the first locking device lever activation area, the first locking device lever body area used to hingely secure the first locking staircase lever within the first locking device housing, and a first locking device lever tab member extending outward and downward from the first locking device lever body area, the first locking device lever tab member configured to extend down through the channel allowing the first locking device staircase lever to engage one or more of the plurality of notches formed on the flat section of the second segment to hold the second segment at a desired length;
a first locking device pivot pin to pivotably couple the first locking device staircase lever in the first locking device housing; and
a first locking device spring positioned under the first locking device staircase lever to exert an upward force on the first locking device staircase lever.

20. The telescopic handle of claim 18, wherein the second locking device lever is a second locking device spring loaded lever comprising:
a second locking device staircase lever having a second locking device lever activation area allowing pressing and releasing of the second locking staircase lever, a second locking device lever body area extending outward and downward from the second locking device lever activation area, the second locking device lever body area used to hingely secure the second locking staircase lever within the second locking device housing, and a second locking device lever tab member extending outward and downward from the second locking device lever body area, the second locking device lever tab member configured to extend down through the channel allowing the second locking device staircase lever to engage one or more of the plurality of notches formed on the flat section of the second segment to hold the second segment at a desired length;
a second locking device pivot pin to pivotably couple the second locking device staircase lever in the second locking device housing; and
a second locking device spring positioned under the second locking device staircase lever to exert an upward force on the second locking device staircase lever.
